(19) United States
(12) Patent Application Publication
(10) Pub. No.: US 2026/0330320 A1
(43) Pub. Date: Oct. 22, 2026

(54) TECHNIQUES FOR USE OF MULTI-TIER MEMORY THAT INCLUDES POOLED PERSISTENT MEMORY

(71) Applicant: Intel Products IP LLC, Santa Clara, CA (US)

(72) Inventors: Benny Shi Huang LIM, Butterworth (MY); Chwee Liong TEE, Kedah (MY); Meng Kean KU, Bukit Mertajam (MY); Zailani MOHD NORDIN, Kedah (MY); Winston HUDSON, Santa Clara, CA (US)

(21) Appl. No.: 19/705,193

(22) Filed: Jun. 11, 2026

(51) Int. Cl. G06N 20/00; G06N 5/04

(52) U.S. Cl. CPC G06N 20/00; G06N 5/04

(57) ABSTRACT

Examples include techniques associated with use of multi-tier memory that includes pooled persistent memory. The use of multi-tier memory that includes pooled persistent memory can include use of a first cache maintained at an accelerator to maintain active tokens to be used by the accelerator to execute an inference application or to train a model for an artificial intelligence model and use of pooled persistent memory on a memory device coupled with the accelerator through a fabric to store active tokens evicted or moved from the first cache. Examples also include the pooled persistent memory being accessible to the accelerator and at least one other accelerator through the fabric.

### BACKGROUND

A rapid rise in artificial intelligence (AI) that includes training of AI models and inference applications of those trained AI models has increased an importance of a role that clusters of accelerators such as graphic processing unit (GPU) clusters serve in the training and use of inference applications for AI models. AI model training can include transformer training and inference applications of those trained AI models can include large language model (LLM) inference.

### BRIEF DESCRIPTION OF THE DRAWINGS

FIG. 1 illustrates an example system.

FIG. 2 illustrates an example of a portion of the system.

FIG. 3 illustrates an example tier cache management scheme.

FIG. 4 illustrates an example first flow.

FIG. 5 illustrates an example second flow.

FIG. 6 illustrates an example third flow.

FIG. 7 illustrates an example logic flow.

FIG. 8 illustrates an example second system.

### DETAILED DESCRIPTION

Modern AI workloads (LLM inference, transformer training) can face memory hierarchy bottlenecks that can limit scalability/efficiency and raise operating costs. Current systems that can include clusters of accelerators (e.g., GPUs) can enforce hard constraints through three limitations. A first limitation can be a key value (KV) cache bottleneck. For this first limitation, LLM inference can generate context-dependent KV caches for accelerators included in a cluster that can exceed 100 gigabytes (GB) for storing around 100,000 AI workload units of data herein referred to as “tokens” in a single-user/tenant scenario, scaling to 1-10 terabytes (TB) in a multi-tenant scenario. Current solutions related to this first limitation can either keep KV cache in a type of memory (e.g., high bandwidth memory (HBM) that can be expensive (e.g., $40,000-60,000 per 100 GB of HBM capacity) or can offload some of the KV cache to a substantially less expensive type of memory (e.g., non-volatile flash memory) included on a solid state drive (SSD) that can have an access latency 100× slower than the more expensive type of memory (e.g., HBM). This cost vs. efficiency/performance tradeoff to address this first limitation can create a ‘memory capacity cliff’ that can prevent a longer token context window and can also reduce LLM inference throughput by 30-60%.

A second limitation can be training checkpoint recovery inefficiency. For training checkpoint recover inefficiency, large model training (e.g., 70-billion (70B) or 405-billion (405B) parameter scale) can generate checkpoints every 1-4 hours. Typically each checkpoint consumes 50 GB-2 TB of memory capacity. During distributed training failures (e.g., can occur every 2-6 hours in a cluster of 10,000 accelerators/GPUs), recovery from the last valid checkpoint can require 5-15 minutes to reload checkpoint data from a distributed SSD storage array. This 5-15 minutes of reload time can translate to 5-25% cluster utilization loss per failure event. Current asynchronous checkpoint solutions involving a distributed SSD storage array can incur 15-30% memory bandwidth overhead and may not prevent data corruption during training.

A third limitation can be inference serving infrastructure inefficiency. For example, a multi-tenant LLM inference deployment serving 100-10,000 concurrent requests may need to maintain separate KV caches per request. The separate KV caches per request can create a quadratic memory scaling problem. A 70B parameter model serving 100 concurrent users, for example, can require 5-20 TB of KV cache memory capacity. If the 70B parameter model is scaled to 1,000 concurrent users with next-generation 405B parameter models, 50-100 TB of KV cache memory capacity would be needed. This 50-100 TB of KV cache memory capacity can make accelerator/GPU clusters that use only HBM types of memory for KV cache uneconomical (e.g., at an estimated cost of $3M-6M for HBM memory per cluster) and can force hyperscalers to either limit a number of concurrent users or accept sub-optimal latency for inference results.

Attempts to address the three limitations mentioned above fall into three categories. A first category includes brute-force HBM expansion that can scale HBM to 200 GB-300 GB per accelerator/GPU but can cost an estimated $40K-60K per 100 GB added, creating millions of dollars in cost per inference cluster that can include 100's of accelerator/GPUs. Also, a power budget impact due to adding this large amount of HBM can be substantial. This type of brute-force HBM expansion can lack flexibility for mixed-GPU environments as the added HBM may only work with a specific accelerator/GPU.

A second category can include SSD-based offloading and tiering. For example, PyTorch's Offload-tuned training, DeepSpeed Offload, and vLLM's PagedAttention can cache KV to distributed SSDs (e.g., secondary storage tier) through a Non-Volatile Memory Express (NVMe) fabric. Benefits of this second category can include capacity (can reach 100 TB+ with NVMe fabric) and cost (non-volatile flash memory on a SSD at an estimated cost of $0.10-0.15/GB vs. HBM at $300-400/GB). However, latency penalties can be severe for access to distributed SSDs. For example, random access at 10-50 microseconds (us) can create a token generation latency increase of 50-150 millisecond (ms) per token compared to HBM access latency. Also, for distributed training, checkpoint reload through an NVMe fabric coupled to distributed SSDs can take 5-15 minutes for models having checkpoints that can consume up to 2 TB of memory capacity. Also, non-volatile flash memory on SSDs can have wear endurance limits of 5-10 years under continuous checkpoint writes and may have to be replaced at or near these endurance limits.

A third category is software-only cache optimization such as grouped-query attention or KV cache quantization. Grouped-query attention can reduce a memory capacity needed for a KV cache by 8× and KV cache quantization can add another 2-4× reduction. Thus, this third category can lower effective memory capacity for a KV cache from 260 GB to 8-16 GB per 100,000 tokens. However, this third category provides an incremental improvement but delays the problem of a need for a large amount of HBM capacity and does not fully address a growing need for larger and larger amounts of HBM capacity for KV caches. AI models continue to scale to larger hidden dimensions (6,000-14,000 dimensions in next-gen models) and token demands keep increasing for increasing parameter models. Even with grouped-query or KV cache quantization, multi-tenant scenarios that can serve of 100+ concurrent 405B parameter models can still require 50-100 TB of KV cache memory capacity and thus this third category of software-only cache optimizations fails to fully address any of the three limitations mentioned above.

As described in more detail below, a multi-tier memory architecture that includes a persistent memory pool can be implemented. As part of this implementation, the persistent memory pool can be made accessible to accelerators or GPUs included in an accelerator cluster via use of interconnect or fabric coherency protocols. Accessibility to the persistent memory pool can expand memory capacity available for a KV cache. In some examples, battery-backed DRAM modules or ferroelectric random access memory/magnetoresistive random access memory (FeRAM/MRAM) technology with coherency protocols in accordance with a specification published by the Compute Express Link (CXL) Consortium to include, but not limited to, the CXL Specification, Revision 4.0, Version 1.0, published on Aug. 13, 2025 (hereinafter referred to as “CXL 4.0”) and/or previous or subsequent revisions of the CXL specification (e.g., CXL 1.0, 2.0, 3.0 or 5.0). Coherency protocols described in CXL 4.0, for example, can be host-initiated and can create a system address space mapped to a persistent memory pool that is shared and accessible by accelerators/GPUs of the accelerator cluster. The persistent memory pool can be accessible with less than a 300 nanosecond (ns) latency and with about 50-80 GB/s data access bandwidth. Memory devices included in the persistent memory pool can include persistent memory configured to retain content across a power cycling. This type of multi-tier memory architecture can enable a tiered KV cache management where hot/recent tokens associated with executing inference applications of AI models can reside in a first tier that includes HBM and older/context tokens can reside in a second tier that includes the persistent memory pool. Therefore, the amount of HBM memory capacity needed to support a KV cache for executing inference applications of AI models can be substantially reduced. This type of multi-tier memory architecture can also enable fast checkpoint recovery to allow AI model state snapshots/checkpoints for training of AI models to persist in the persistent memory pool with a less than 500 ms recovery time that can significantly reduce training downtime compared to storing checkpoints to SSDs. This type of multi-tier memory architecture can also enable for a unified/shared persistent memory pool for multi-tenant inference where KV caches maintained in the second tier that includes the persistent memory pool can scale elastically to high memory capacities for second tier KV caches that are system address space mapped across the unified/shared persistent memory pool and can be accessed with little to no per-request allocation penalties.

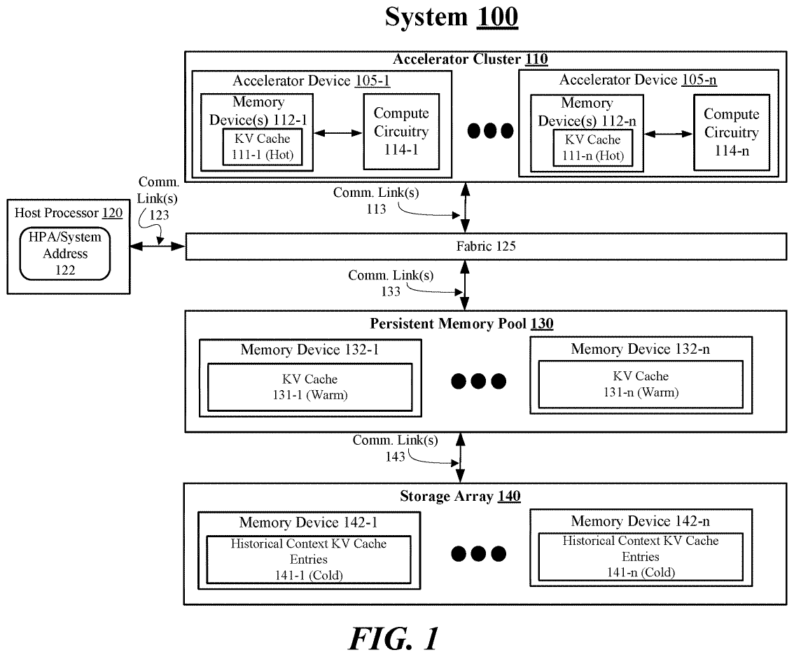

FIG. 1 illustrates an examples system 100. System 100, as shown in FIG. 1, includes an accelerator cluster 110, a host processor 120, a persistent memory pool 130, a storage array 140, and a fabric 125. According to some examples, as shown in FIG. 1, accelerator cluster 100 can include one or more accelerator devices 105-1 to 105-n that separately include memory device(s) 112-1 to 112-n directly coupled with respective compute circuitry 114-1, were “n” can be any whole positive integer greater than 1. Also as shown in FIG. 1, persistent memory pool 130 can include one or more memory devices 132-1 to 132-n and storage array 140 can include one or more memory devices 142-1 to 142-n. As described more below, memory device(s) 112, 132 and 142 can be configured to support a multi-tier memory architecture.

According to some examples, the multi-tier memory architecture can include configuring key value (KV) caches 111-1 to 111-n within memory maintained by memory devices(s) 112-1 to 112-n as a first tier of a multi-tier memory architecture. The memory maintained by memory device(s) 112-1 to 112-n can be, but is not limited to, high bandwidth memory (HBM) such as described by various standards or specifications originally released by Joint Electronic Device Engineering Council (JEDEC) such as JESD229-2 originally published in August 2014, HBM, JESD235, originally published in October 2013, HBM 2 (HBM version 2), JESD235C, originally published in January 2020, HBM 3 (HBM version 3), JESD238, originally published in January 2022, or HBM 4 (HBM version 4), JESD240-4, originally published in April 2025, or others types of HBM based on derivatives or extensions of the JEDEC specifications listed above. KV caches 111-1 to 111-n can be arranged, for example, to maintain hot/recent tokens associated with compute circuitry 114-1 to 114-n executing inference applications of AI models. Compute circuitry 114-1 to 114-n can include graphics processing units (GPUs) that can be arranged to execute the inference applications of AI models. In addition to GPUs, compute circuitry 114-1 to 114-n can also include one or more application specific integrated circuits (ASICs) or one or more field programmable gate arrays (FPGAs). In some examples, compute circuitry 114-1 to 114-n can include a combination of GPUs, FPGAs or ASICs.

In some examples, the multi-tier memory architecture can include configuring KV caches 131-1 to 131-n within memory maintained by memory devices(s) 132-1 to 132-n of persistent memory pool 130 as a second tier of a multi-tier memory architecture. The memory maintained by memory device(s) 132-1 to 132-n can be, but is not limited to, battery-back DRAM and/or FeRAM/MRAM. KV caches 131-1 to 131-n can be arranged, for example, to maintain older/context tokens associated with compute circuitry 114-1 to 114-n executing inference applications of AI models. According to some examples, host processor 120 can map physical memory addresses associated with KV caches 131-1 to 131-n as a type of CXL 4.0 persistent memory maintained at memory devices 132-1 to 132-n (e.g., battery-backed DRAM) to host physical addresses/system address 122 and then coordinate with logic and/or circuitry included in compute circuitry 114-1 to 114-n to recognize these mapped memory addresses for KV caches 131-1 to 131-n as a coherent extension of their respective KV cache memory address spaces. This second tier of KV cache included in KV caches 131-1 to 131-n can be identified by host processor 120 and/or compute circuitry 114-1 to 114-n as a type of pooled/shared CXL 4.0 persistent memory that can be accessed via communication link(s) 113 and 133 through fabric 125 using CXL 4.0 coherency protocols (e.g., CXL. mem/cache protocol implementations). Also, memory devices 132-1 to 132-n can be referred to as CXL 4.0 type 2 device memory and coherence management of KV caches 131-1 to 131-n can be as host-managed device memory (HDM) that is configured as device coherent (HDM-D) or device coherent using back-invalidate snoop (HDM-DB). The memory arranged to maintain KV caches 131-1 to 131-n can be configured to retain content across a power cycling. This memory can be identified as CXL 4.0 persistent memory. As CXL 4.0 persistent memory, writes to KV caches 131-1 to 131-n use CXL 4.0 coherency protocols. In one example where memory devices 132-1 to 132-n included battery-backed DRAM, Writes to KV caches 131-1 to 131-n can be stored to volatile DRAM but battery power can be used during a power cycle to flush what has been written or stored in KV caches 131-1 to 131-n to a non-volatile memory media (e.g., NAND flash memory) also maintained at memory device(s) 132. Hence, maintaining the persistence of data written to KV caches 131-1 to 131-n across a power cycling (the non-volatile memory media to receive flushed data at memory device(s) 132 is not shown in FIG. 1). The memory arranged to maintain KV caches 131-1 to 131-n can also be configured to be exposed as a direct-access (DAX) persistent memory to enable KV caches 131-1 to 131-n to be accessed as byte-addressable memory.

In some examples, where memory device(s) 132 can be arranged to include battery-backed DRAM, Memory device(s) 132 can be one or more non-volatile dual in-line memory modules (NVDIMMs) configured to operate according specifications published by JEDEC to include, but not limited to, the DDR4 NVDIMM-P Bus Protocol, JESD304-4.01, published in January 2021 or the Byte Addressable Energy Backed Interface, JESD245B.01, published in September 2017. In other examples, memory device(s) 132 can be located on a same package as host processor 120 and/or compute circuitry 114 and configured as an integrated persistent memory. For these other examples, memory device(s) 132 can include FeRAM or MRAM types of memory that can meet CXL 4.0 requirements for persistent memory and fabric 125 can be included as a package substrate connection in order to enable memory device(s) 132 to be configured as an integrated persistent memory.

According some examples, the multi-tier memory architecture can include configuring memory devices(s) 142-1 to 142-n as a third tier of the multi-tier memory architecture. The memory maintained by memory device(s) 142-1 to 142-n can be, but is not limited to, non-volatile flash memory (e.g., NAND flash memory). Also, memory device(s) 142-1 to 142-n can be SSDs included in storage array 140 and can be configured to be accessed via communication link(s) 143 in accordance with the NVMe Base Specification, Revision 2.3, published Jul. 31, 2025, by NVM Express (hereinafter referred to as “the NVMe specification”). SSDs configured to be accessed in accordance with the NVMe specification can be referred to as NVMe SSDs. For these examples, historical context KV cache entries 141-1 to 141-n can include cold/historical context tokens. The cold/historical context tokens be associated with execution, by compute circuitry 114-1 to 114-n, of inference applications of AI models that have become inactive or idle.

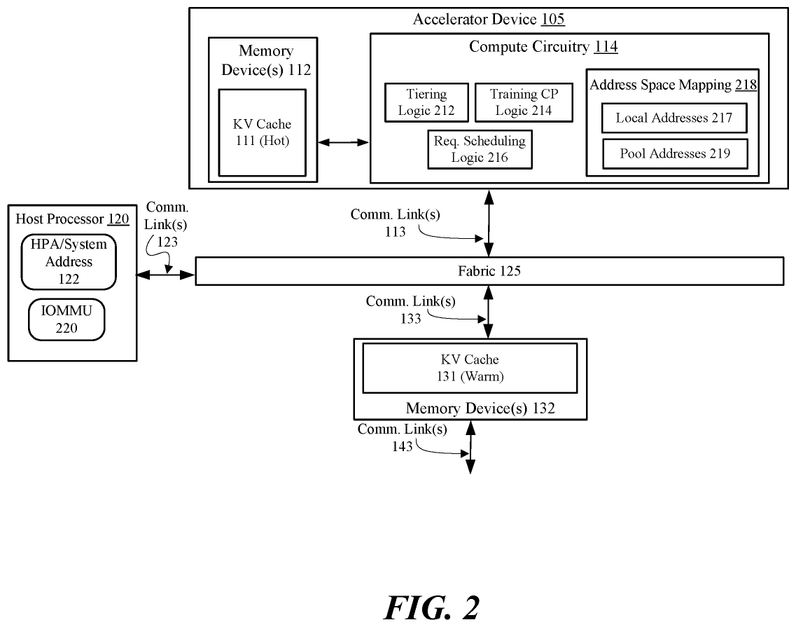

FIG. 2 illustrates an example portion of system 100 that includes host processor 120 coupled with accelerator device 105 and one or more memory device(s) 132 through fabric 125. According to some examples, these portions of system 100 can utilize communication link(s) 113, 123 or 133 configured in accordance with CXL 4.0 to couple through fabric 125 that is also configured in accordance with CXL 4.0. As mentioned previously, KV cache 111 at memory device(s) 112 can be configured as a first tier (e.g., tier-0) and KV cache 131 can be configured as a second tier (e.g., tier-1). The third tier (e.g., accessible via communication link(s) 143) is not shown in FIG. 2 in order to simplify the description of the first two tiers.

In some examples, as shown in FIG. 2, compute circuitry 114 of accelerator device 105 includes a tiering logic 212, a training checkpoint (CP) logic 214 and a request scheduling logic 216. As described more below, tiering logic 212 can facilitate implementation of a KV cache tiering flow, training CP logic 214 can facilitate implementation of a training checkpoint flow for training an AI model and request scheduling logic 216 can facilitate implementation of a multi-tenant inference request scheduling flow. Tiering logic 212, training CP logic 214 or request scheduling logic 216 can collectively be supported or executed by a same portion of compute circuitry 114 or can be supported or executed by two or more portions of compute circuitry 114.

According to some examples, address space mapping 218 can be configured to include local addresses 217 and pool addresses 219. For these examples, compute circuitry 114 can include logic and/or features to map memory addresses associated with KV cache 111 maintained locally at memory device(s) 112 at local addresses 217. The memory addresses associated with KV cache 111 at local addresses 217 can make up the first tier of the multi-tier memory architecture. In some examples, an input/output memory management unit (IOMMU) 220 at host processor 120 can utilize HPA/system address 122 to enable the logic and/or features of compute circuitry 114 to include physical memory addresses associated with KV caches 131-1 to 131-n maintained in memory at memory devices 132-1 to 132-n as pool addresses 219. For example, IOMMU 220 can provide a translation table to enable compute circuitry 114 to recognize pool addresses 219 as a coherent extension to its address space mapping 218 in accordance with CXL 4.0 that can be accessed for use as a second tier KV cache using CXL 4.0 coherency protocols.

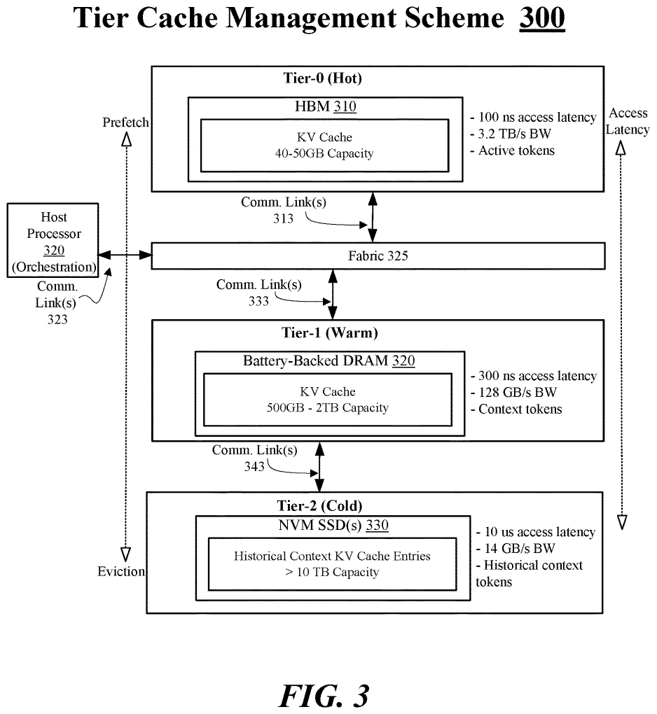

FIG. 3 illustrates an example tier cache management scheme 300. According to some examples, example tier cache management scheme 300 shows an example of a setup of a multi-tier memory architecture. For these examples, as shown in FIG. 3, a first tier-0 (hot) can include a high bandwidth memory (HBM) 310 to maintain a KV cache having a capacity of 40-50 GB, a second tier-1 (warm) can include battery-backed DRAM 320 to maintain a KV cache having a capacity of 500 GB to 2 TB, and a third tier-2 (cold) can include non-volatile memory solid state drives (NVM SSD(s)) 330 to maintain historical context KV cache entries and have a >10 TB capacity.

In some examples, the KV cache maintained in HBM 310 can have access latency of around 100 ns, a bandwidth (BW) of 3.2 TB/second and is operated to maintain active tokens. Determining what is an active token can be based on a “hotness” score that can indicate a recency of when a given token is stored to the KV cache maintained in HBM 310 in relation to other tokens stored to this KV cache. The hotness score can be based on a least recently used (LRU) eviction policy. The LRU eviction policy can cause tokens with a hotness score, for example, that exceeds a first threshold to be evicted to the KV cache maintained in battery-backed DRAM 320. The first threshold, for example, can correspond to an amount of active tokens that can be stored to HBM 310 (e.g., 4,000-8,000 active tokens).

According to some example, the KV cache maintained in battery-backed DRAM 320 can have an access latency of around 300 ns, a BW of 128 GB/s and is operated to maintain once active tokens evicted from the KV cache maintained in HBM 310. For these example, the once active tokes can be considered as context tokens. The KV cache maintained in battery-backed DRAM 320 can be configured as pooled or shared CXL 4.0 persistent memory similar to KV caches 131-1 to 131-n described above for FIGS. 1-2 that can be accessed via communication link(s) 313 and 333 through fabric 325 using CXL 4.0 coherency protocols. In some examples, context tokens can be considered as historical context tokens, for example, when a hotness score for a context reaches a second threshold. The hotness score for the context token can also be based on an LRU policy implemented for the KV cache maintained in battery-backed DRAM 320. This LRU policy implemented for the KV cache maintained in battery-backed DRAM 320 can cause tokens with a hotness score, for example, that exceeds the second threshold to be evicted to the historical context KV cache entries maintained in NVM SSD(s) 330. The second threshold, for example, can correspond to an amount of context tokens that can be stored to battery-backed DRAM 320 (e.g., up to 100,000 context tokens). Although not shown in FIG. 2 for battery-backed DRAM 320, a battery-backing mechanism such as a super capacitor or lithium battery (e.g., 50-100 joule (J) capacity) to allow for a 30-60 second power-loss data preservation window can be used by battery-backed DRAM to meet CXL 4.0 requirements for use as persistent memory.

In some examples, a prefetch strategy can be orchestrated for context tokens to be prefetched from the KV cache maintained in battery-backed DRAM 320 to the KV cache maintained in HBM 310. For example, an attention mechanism associated with the prefetch can be deterministic for the prefetch strategy. An autoregressive decoding can be orchestrated via which a next layer KV access pattern can be known via which context tokens will regress back to active tokens. Logic and/or features of a compute circuitry coupled with HBM 310 (e.g., tiering logic 212 or other logic and/or feature(s) of compute circuitry 114) can issue speculative prefetch commands through fabric 125 to prefetch the context tokens in order to hide access latency compared to accessing from the KV cache maintained in HBM 310 (e.g., while computing layer n tokens, prefetch layer n+1 tokens from the KV cache maintained in battery-backed DRAM 230).

According to some example, historical context KV cache maintained in battery-backed DRAM 320 can have an access latency of around 300 ns, a BW of 128 GB/s and is operated to maintain historical context tokens evicted from the KV cache maintained in battery-backed DRAM 320. For these example, communication link(s) 343 can be arranged to operate according to the NVMe specification. Historical context tokens, for example, can be associated with inactive or idle requests (e.g., for inference applications) that may transition back to active requests and thus are not part of a working set of tokens.

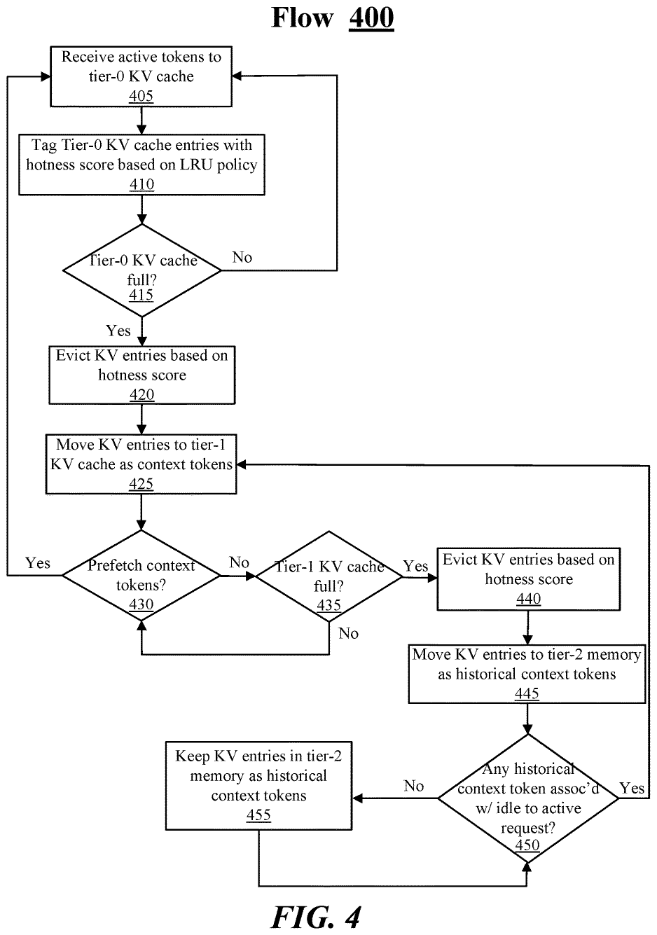

FIG. 4 illustrates an example flow 400. In some examples, flow 400 provides an example KV cache tiering flow for inference applications. For these examples, flow 400 can be implemented by elements or components of system 100 as shown in FIGS. 1 and 2 such as, but not limited to, logic and/or features of compute circuitry 114 (e.g., tiering logic 212), fabric 125, logic and/or features of host processor 120 (e.g., IOMMU 220), memory device(s) 112, memory device(s) 132 or memory device(s) 142.

According to some examples, flow 400 at block 405 is to receive active tokens to tier-0 KV cache. For these examples, tiering logic 212 of compute circuitry 114 can cause KV cache 111 at memory device(s) 112 to receive the active tokens based on local addresses 217 included in compute circuitry 114's address space mapping 218. KV cache 111, as mentioned above, can be configured to be included in tier-0 of a multi-tier memory architecture.

In some examples, flow 400 at block 410 is to tag tier-0 KV cache entries with hotness score based on LRU policy. For these examples, tiering logic 212 can tag active tokens maintained in KV cache 111 with a hotness score.

According to some examples, flow 400 at decision block 415 is to determine whether the tier-0 KV cache is full. If the tier-0 KV cache is full, flow 400 moves to block 420. Otherwise, flow 400 moves to block 405. For these examples, tiering logic 212 determines whether the tier-0 KV cache is full.

In some examples, flow 400 at block 420 is to evict KV entries based on hotness score. For these examples, tiering logic 212 can determine that active tokens with a hotness score exceeding a first threshold are to be evicted from KV cache 111 (tier-0).

According to some examples, flow 400 at block 425 is to move KV entries to tier-1 KV cache as context tokens. For these examples, tiering logic 212 can move the KV entries to tier-1 KV cache 131 maintained at memory device(s) 132 of persistent memory pool 130 based on pool addresses 219 included in compute circuitry 114's address space mapping 218. The KV entries can be routed over communication link(s) 113 and 133 and through fabric 125 using CXL 4.0 coherency protocols to cause the contents of the KV entries to be moved to KV cache 131 as context tokens.

In some examples, flow 400 at decision block 430 is to determine whether to prefetch context tokens. If context tokens are to be prefetched, flow 400 moves to block 405. Otherwise, flow 400 moves to decision block 435. For these examples, tiering logic 212 can determine, based, at least in part, on a deterministic prefetch strategy to issue a speculative prefetch command if a determination is made to select a context token for prefetching. The speculative prefetch command can cause the selected context token to be stored back to tier-0 KV cache 111 as an active token.

According to some examples, flow 400 at decision block 435 is to determine whether the tier-1 KV cache is full. If tier-1 KV cache is full, flow 400 moves to block 440. Otherwise, flow 400 moves to decision block 430. For these examples, based on CXL 4.0 coherency protocols and monitoring of HPA/System address 122, host processor 120 can determine whether KV cache 131 has reached its memory capacity. Also, tiering logic 212 may monitor pool addresses 219 of compute circuitry 114's address space mapping 218 and determine that all addresses in pool addresses 219 include context tokens and this can also be a way to determine whether KV cache 131 has reached its capacity.

In some examples, flow 400 at block 440 is to evict KV entries based on hotness score. For these examples, either host processor 120 or tiering logic 212 can cause context token KV entries to be evicted from KV cache 131 based on a hotness score that exceeds a second threshold. HPA/system address 122 and/or pool addresses 219 can then be updated to reflect that memory addresses for KV cache 131 corresponding to the evicted KV entries are available to receive context tokens moved from KV cache 111.

According to some examples, flow 400 at block 445 is to move KV entries to tier-2 memory as historical context tokens. For these examples, either host processor 120 or tiering logic 212 can cause context tokens selected for eviction from KV cache 131 to be moved to historical context KV cache entries 141 maintained in memory devices 142-1 of storage array 140. In some examples, the context tokens moved to historical context KV cache entries can be sent over communication link(s) 143 in accordance with the NVMe specification.

In some examples, flow 400 at decision block 450 is to determine if any historical context tokens are associated with idle to active request. If one or more historical context tokens are associated with an idle to active request, flow 400 moves to block 425. Otherwise, flow 400 moves to block 455. For these examples, tiering logic 212 can receive an indication that historical context tokens that were moved to tier-2 memory are associated with a request for an inference application to be executed by compute circuitry 114 that moved from idle, no new requests for the inference application, to active, new requests received for the inference application. These historical context tokens can then be moved from tier-2 memory to tier-1 memory as content tokens that can then be prefetched to tier-0 memory prior to scheduled use in the AI inference application. In some examples, the historical context tokens can be moved from memory device(s) 142 (tier-2) to memory device(s) 132 (tier-1) over communication link(s) 143 in accordance with the NVMe specification. HPA/system address 122 and/or pool addresses 219 can then be updated to reflect that memory addresses for KV cache 131 corresponding to the where the historical context tokens were stored as context tokens are no longer available to receive context tokens moved from KV cache 111.

According to some examples, flow 400 at block 455 is to keep KV entries in tier-2 memory as historical context tokens. For these examples, historical context tokens maintained in historical context KV cache entries 142 of memory device(s) 142 at storage array 140. Flow 400 can then return to decision block 450.

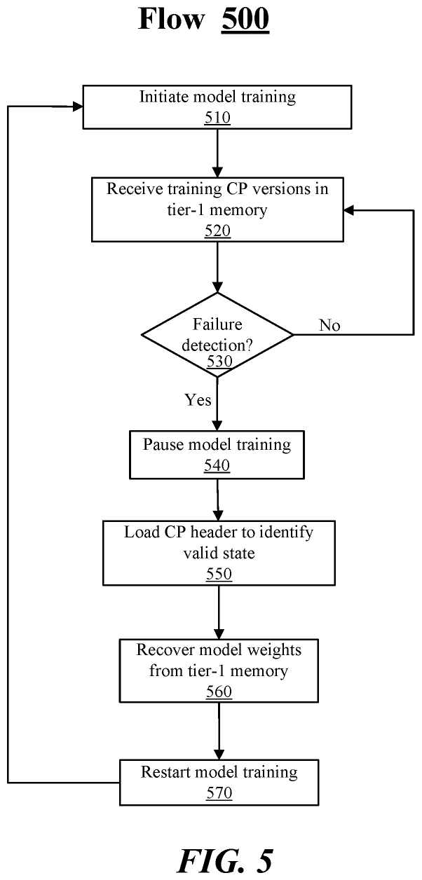

FIG. 5 illustrates an example flow 500. In some examples, flow 500 provides an example training checkpoint flow for training an AI Model. For these examples, flow 400 can be implemented by elements or components of system 100 as shown in FIGS. 1 and 2 such as, but not limited to, logic and/or circuitry of compute circuitry 114 (e.g., training CP logic 214), fabric 125, fabric 125, memory device(s) 112 or memory device(s) 132.

According to some examples, flow 500 at block 510 is to initiate model training. For these examples, compute circuitry 114 can initiate model training for an AI model such as a large language model.

In some examples, flow 500 at block 520 is to receive training checkpoint (CP) versions in tier-1 memory. For these examples, training CP logic 214 of compute circuitry 114 can route the training CP versions to tier-1 memory through fabric 125 using pool addresses 219 to target persistent memory maintained in memory device(s) 132 of persistent memory pool 130 to cause the training CP versions to be received in tier-1 memory. CXL 4.0 coherency protocols can be used to cause the training CP versions to be received in tier-1 memory maintained in memory device(s) 132. According to some examples, 3-5 concurrent CP versions can be received in tier-1 memory during training of a given AI model. Each version for a 70B parameter AI model, for example, can consume around 50-200 GB of tier-1 memory capacity. A training CP version, for example, could be received in tier-1 memory every 1-4 hours during model training.

According to some examples, flow 500 at decision block 530 is to determine whether a failure is detected. If no failure is detected, flow 500 moves to block 520. If a failure is detected, flow 500 moves to block 540. For these examples, training CP logic 214 can receive an indication that a failure occurred during training of the AI module by compute circuitry 114 in order to determine that a failure was detected.

In some examples, flow 500 at block 540 is to pause model training. For these examples, compute circuitry 114 pauses AI model training responsive to the detected failure. This pause, for example, can cost a one loss backward pass that can be approximately 100 ms.

According to some examples, flow 500 at block 550 is to load a CP header to identify a valid state. For these examples, training CP logic 214 can load the CP header from the persistent memory at tier-1 maintained in memory device(s) 132 in order to identify a valid state for at least one CP version stored to the tier-1 memory. The CP header, for example, can include about 1 kilobyte (KB) of data that can be used by training CP logic 214 to identify the valid state for the at least one CP version.

In some examples, flow 500 at block 560 is to recover model weights from tier-1 memory. For these examples, training CP logic 214 can cause the model weights from tier-1 for the at least one CP version that was identified in the valid state to be recovered from the memory maintained in memory device(s) 132 and stored to KV cache 111 of memory device(s) 112. The CP header, for example, can include information to indicate memory addresses that match memory addresses included in pool addresses 219 to indicate to training CP logic 214 from where to recover the model weights for the at least one CP version.

According to some examples, flow 570 is to restart model training. For these examples, once the model weights are recovered, training CP logic 214 can cause compute circuitry 114 to restart model training. Flow 500 can then return to block 510.

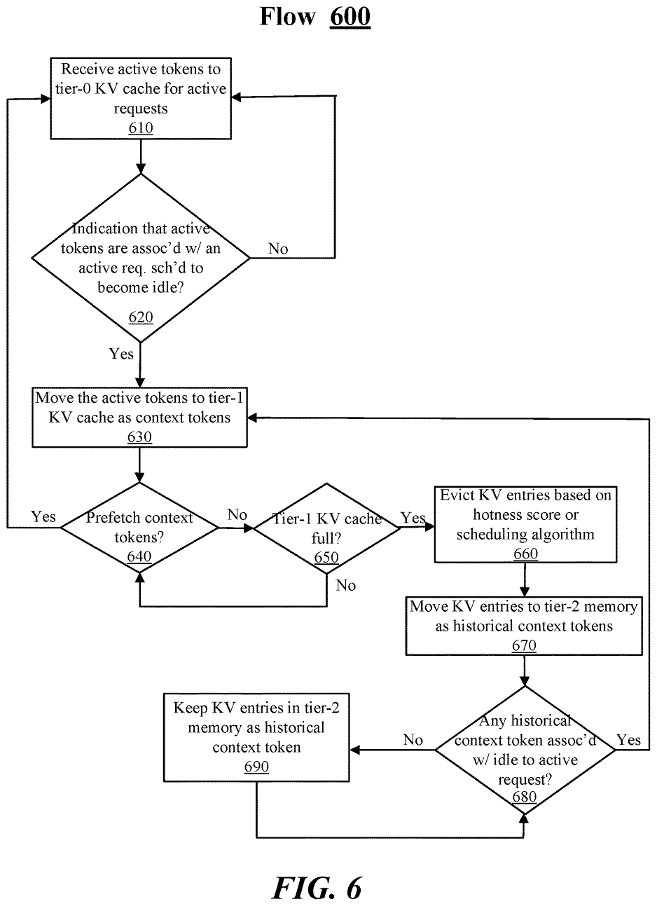

FIG. 6 illustrates an example flow 600. In some examples, flow 600 provides an example multi-tenant inference request scheduling flow. For these examples, flow 600 can be implemented by elements or components of system 100 as shown in FIGS. 1 and 2 such as, but not limited to, logic and/or circuitry of compute circuitry 114 (e.g., tiering logic 212 or request scheduling logic 216), fabric 125, logic and/or circuitry of host processor 120 (E.g., IOMMU 220), memory device(s) 112, memory device(s) 132 or memory device(s) 142.

According to some examples, flow 600 at block 610 is to receive active tokens to tier-0 KV cache for active requests. For these examples, request scheduling logic 216 of compute circuitry 114 can cause KV cache 111 at memory device(s) 112 to receive the active tokens for active requests based on local addresses 217 included in compute circuitry 114's address space mapping 218. KV cache 111, as mentioned above, can be configured to be included in tier-0 of a multi-tier memory architecture. The active requests can be for an inference application from a trained AI model that is executed by compute circuitry 114, the active requests from multiple tenants.

In some examples, flow 600 at decision block 620 is to determine if an indication that active tokens are associated with an active request scheduled to become idle. If it is determined that active tokens associated with an active request are scheduled to become idle, flow 600 moves to block 630. Otherwise, flow 600 moves to block 610. For these examples, request scheduling logic 216 can implement a scheduler algorithm for multi-tenant inference requests to determine when compute circuitry 114 is idle and is expected/scheduled to not process active tokens maintained in the tier-0 KV cache.

According to some examples, flow 600 at block 630 is to move the active tokens to tier-1 KV cache as context tokens. For these examples, request scheduling logic 216 can cause tiering logic 212 to move the active token to tier-1 KV cache 131 maintained at memory device(s) 132 of persistent memory pool 130 based on pool addresses 219 included in compute circuitry 114's address space mapping 218. The active tokens can be routed over communication link(s) 113 and 133 and through fabric 125 using CXL 4.0 coherency protocols to cause the active tokens to be moved to KV cache 131 as context tokens.

In some examples, flow 600 at decision block 640 is to determine whether to prefetch context tokens. If context tokens are to be prefetched, flow 600 moves to block 610. Otherwise, flow 600 moves to decision block 650. For these examples, request scheduling logic 216 can determine, based, at least in part, on the scheduling algorithm for multi-tenant inference requests to determine that compute circuitry 114 is expected to resume processing the context tokens and can issue a speculative prefetch command through fabric 125. The speculative prefetch command can cause the context tokens to be stored back to tier-0 KV cache 111 as an active token.

According to some examples, flow 600 at decision block 650 is to determine whether the tier-1 KV cache is full. If tier-1 KV cache is full, flow 600 moves to decision block 640. Otherwise, flow 600 moves to decision block 630. For these examples, based on CXL 4.0 coherency protocols, host processor 120 can determine that KV cache 131 has reached its memory capacity. Also, tiering logic 212 and/or request scheduling logic 216 can monitor pool addresses 219 of compute circuitry 114's address space mapping 218 and determine that all addresses in pool addresses 219 include context tokens and this can also be a way to determine whether KV cache 131 has reached its capacity.

In some examples, flow 600 at block 660 is to evict KV entries based on a hotness score or a scheduling algorithm. For these examples, either host processor 120, tiering logic 212 and/or request scheduling logic 216 can cause context token KV entries to be evicted from KV cache 131 based on a hotness score that exceeds a threshold (e.g., indicates LRU) or based on a scheduling algorithm that indicates that the context KV entries are not scheduled to be prefetched back to tier-0 memory for processing by compute circuitry 114. HPA/system address 122 and/or pool addresses 219 can then be updated to reflect that memory addresses for KV cache 131 corresponding to the evicted KV entries are available to receive context tokens moved from KV cache 111.

According to some examples, flow 600 at block 670 is to move KV entries to tier-2 memory as historical context tokens. For these examples, either host processor 120, tiering logic 212 and/or request scheduling logic 216 can cause context tokens selected for eviction from KV cache 131 to be moved to historical context KV cache entries 141 maintained in memory devices 142-1 of storage array 140. In some examples, the context tokens moved to historical context KV cache entries can be sent over communication link(s) 143 in accordance with the NVMe specification.

In some examples, flow 600 at decision block 680 is to determine if any historical context tokens are associated with idle to active request. If one or more historical context tokens are associated with an idle to active request, flow 600 moves to block 630. Otherwise, flow 600 moves to block 690. For these examples, tiering logic 212 and/or request scheduling logic 216 can receive an indication that historical context tokens that were moved to tier-2 memory are associated with a multi-tenant inference request for an inference application of an AI model that is scheduled to be executed by compute circuitry 114. These historical context tokens can then be moved from tier-2 memory to tier-1 memory as content tokens that can then be prefetched to tier-0 memory prior to scheduled use in the inference application. In some examples, the historical context tokens can be moved from memory device(s) 142 (tier-2) to memory device(s) 132 (tier-1) over communication link(s) 143 in accordance with the NVMe specification. HPA/system address 122 and/or pool addresses 219 can then be updated to reflect that memory addresses for KV cache 131 corresponding to where the historical context tokens were stored as context tokens are no longer available to receive context tokens moved from KV cache 111.

According to some examples, flow 600 at block 690 is to keep KV entries in tier-2 memory as historical context tokens. For these examples, historical context tokens are maintained in historical context KV cache entries of memory device(s) 142 at storage array 140. Flow 600 can then return to decision block 680.

Included herein is a logic flow representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware examples, a logic flow can be implemented by computer executable instructions stored on at least one non-transitory computer readable medium or machine readable medium, such as an optical, magnetic or semiconductor storage. The examples are not limited in this context.

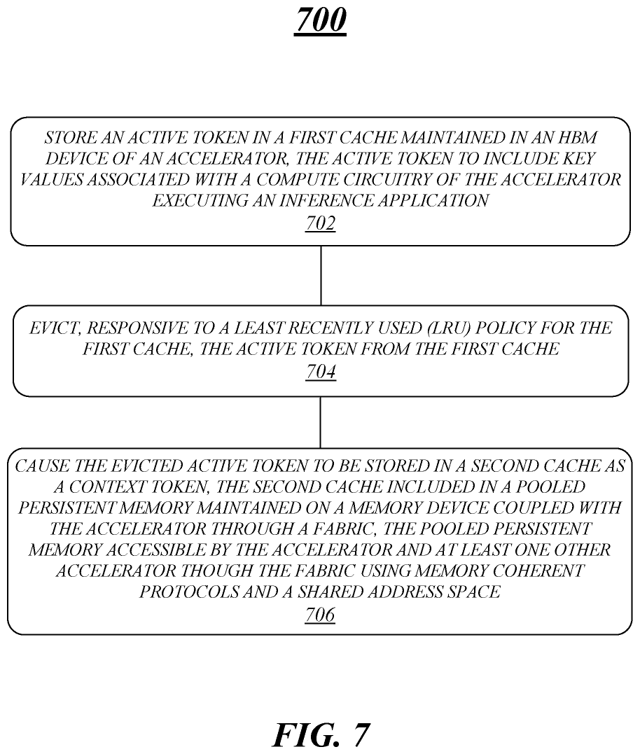

FIG. 7 illustrates an example logic flow 700. Logic flow 700 can be representative of some or all of the operations executed by one or more circuitry, logic and/or features described herein, such as logic and/or features of compute circuitry 114 such as, but not limited to tiering logic 212, training CP logic 214 or request scheduling logic 216. Logic flow 700 can represent use of a multi-tier memory that includes pooled persistent memory such as described above for persistent memory pool 130 shown in FIGS. 1-2 or for tier-1 for tier cache management scheme 300 shown in FIG. 3.

In some examples, as shown in FIG. 7, logic flow 700 at block 702 can store an active token in a first cache maintained in an HBM device of an accelerator, the active token to include key values associated with a compute circuitry of the accelerator executing an inference application. For these examples, tiering logic 212 of compute circuitry 114 can cause the active token to be stored to a first cache such as KV cache 111 maintained in memory device(s) 112. Memory device(s) 112 can be devices that include HBM.

According to some examples, as shown in FIG. 7, logic flow 700 at block 704 can evict, responsive to a LRU policy for the first cache, the active token from the first cache. For these examples, tiering logic 212 of compute circuitry 114 can cause the active token to be evicted responsive to a LRU policy that can be based on a hotness score that was tagged to the active token when initially stored to the first cache.

In some examples, as shown in FIG. 7, logic flow 700 at block 706 can cause the evicted active token to be stored in a second cache as a context token, the second cache included in a pooled persistent memory maintained on a memory device coupled with the accelerator through a fabric, the pooled persistent memory accessible by the accelerator and at least one other accelerator though the fabric using memory coherent protocols and a shared address space. For these examples, tiering logic 212 of compute circuitry 114 can cause the evicted active token to be stored to a second cache as a context token. The second cache, for example, can be KV cache 131 included in a pooled persistent memory maintained on a memory device such as memory device(s) 132. The pooled persistent memory can be accessible through fabric 125 using memory coherent protocols such as CXL 4.0 memory coherent protocols and the pooled persistent memory can have a shared address space that is shared between accelerators included in an accelerator cluster such as accelerator cluster 110.

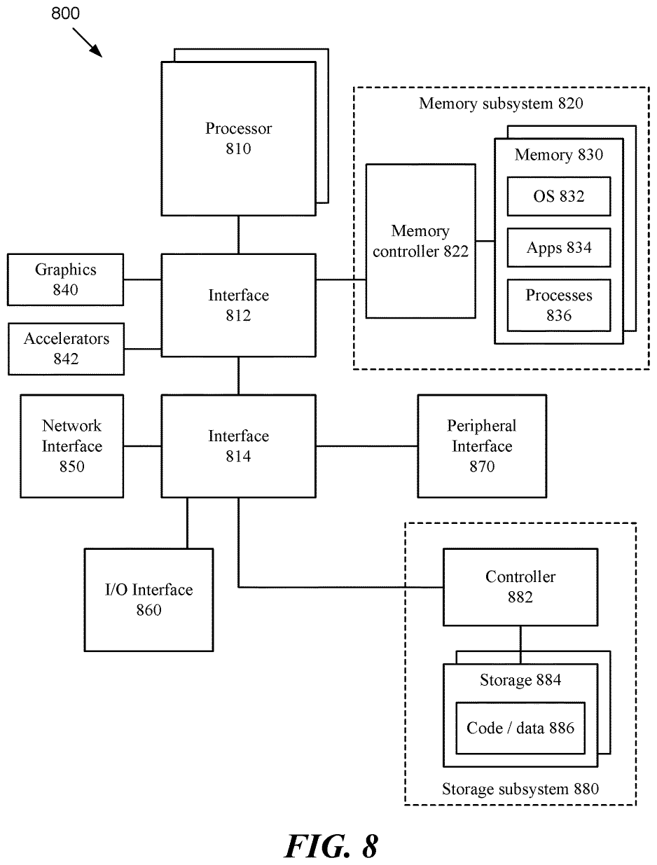

FIG. 8 illustrates an example system 800. System 800 includes processor 810, which provides processing, operation management, and execution of instructions for system 800. Processor 810 can include any type of microprocessor, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function FPGAs). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 810 can include multiple processors and multiple processors can be embodied as processor sockets.

In one example, system 800 includes interface 812 coupled to processor 810, which can represent a higher speed interface or a high throughput interface for system components, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the artificial intelligence (AI) model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container (e.g., Docker container), microservice, processor, or other software. Various examples can perform an application composed of microservices, where a microservice runs in its own process and communicates using protocols (e.g., application programming interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 832 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers, workstations, or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, packet processing device or network interface device 850 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 800 includes one or more input/output (I/O) interface(s) 860. I/O interface 860 can include one or more interface components through which a user interacts with system 800. Peripheral interface 870 can include any hardware interface not specifically mentioned above. Peripherals refer generally to devices that connect dependently to system 800.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 800 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 800 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

One or more aspects of at least one example can be implemented by representative instructions stored on a machine-readable medium which represents various logic within the processor, which when read by a machine causes the machine to fabricate logic to perform the techniques described herein. Such representations, known as “IP cores” can be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, various examples also include non-transitory, tangible machine-readable media containing instructions or containing design data, such as Hardware Description Language (HDL), which defines structures, circuits, apparatuses, processors and/or system features described herein. Such examples may also be referred to as program products.

In some cases, an instruction converter can be used to convert an instruction from a source instruction set to a target instruction set. For example, the instruction converter can translate (e.g., using static binary translation, dynamic binary translation including dynamic compilation), morph, emulate, or otherwise convert an instruction to one or more other instructions to be processed by the core. The instruction converter can be implemented in software, hardware, firmware, or a combination thereof. The instruction converter may be on processor, off processor, or part on and part off processor.

Various examples can be implemented using hardware elements, software elements, or a combination of both. In some examples, hardware elements can include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements can include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

The following examples pertain to additional examples of technologies disclosed herein.

Example 1. An example accelerator device can include a high bandwidth memory device configured to maintain a first cache and compute circuitry arranged to execute an inference application. For this example, the compute circuitry can be configured to store an active token in the first cache, the active token to include key values associated with the compute circuitry executing an inference application. The compute circuitry can also be configured to evict, responsive to an LRU policy for the first cache, the active token from the first cache. The compute circuitry can also be configured to cause the evicted active token to be stored in a second cache as a context token, the second cache included in a pooled persistent memory maintained on a memory device coupled with the accelerator device through a fabric. The pooled persistent memory can be accessible by the accelerator device and at least one other accelerator device though the fabric using memory coherent protocols.

Example 2. The accelerator device of example 1, the compute circuitry can also be configured to cause the context token to be prefetched from the second cache based on an indication that indicates the key values are scheduled to be used by the compute circuitry to execute the inference application. The compute circuitry can also be configured to cause the context token to be received from the second cache over the fabric using the memory coherency protocols; and store the context token as another active token in the first cache.

Example 3. The accelerator device of example 1, the compute circuitry can also be configured to evict, responsive to an LRU policy for the second cache, the context token from the second cache. The compute circuitry can also be configured to cause the evicted context token to be stored to non-volatile memory as historical context tokens. The non-volatile memory can be maintained on a second memory device. The non-volatile memory can be accessible through a communication link that does not use memory coherent protocols.

Example 4. The accelerator device of example 3, the second memory device can be a solid state drive and the communication link can be operated according to an NVMe specification.

Example 5. The accelerator device of example 1, the compute circuitry can execute the inference application responsive to a request. For this example, the compute circuitry can also be configured to determine that the request has become inactive. The compute circuitry can also be configured to cause the context token to be stored to non-volatile memory as historical context tokens. The non-volatile memory can be maintained on a second memory device. The non-volatile memory can be accessible through a communication link that does not use memory coherent protocols.

Example 6. The accelerator device of example 1, the pooled persistent memory maintained on the memory device cab be battery-backed dynamic random access memory, ferroelectric random access memory or magnetoresistive random access memory.

Example 7. The accelerator device of example 1, the memory coherent protocols can be CXL memory coherent protocols.

Example 8. The accelerator device of example 7, the pooled persistent memory can be host-managed device memory (HDM) configured to use the CXL memory coherent protocols based on a device coherent (HDM-D) configuration or a device coherent using back-invalidate snoop (HDM-DB) configuration.

Example 9. The accelerator device of example 1, the compute circuitry can a graphics processing unit, a field programmable gate array, or an application specific integrated circuit.

Example 10. An example method can include storing an active token in a first KV cache maintained in an HBM device of a GPU. The active token can include key values associated with a compute circuitry of the GPU executing an inference application. The method can also include evicting, responsive to an LRU policy for the first cache, the active token from the first KV cache and causing the evicted active token to be stored in a second KV cache as a context token. The second KV cache can be included in a pooled persistent memory maintained on a memory device coupled with the GPU through a fabric. The pooled persistent memory can be accessible by the GPU and at least one other GPU though the fabric using memory coherent protocols and a shared memory address space.

Example 11. The method of example 10 can also include causing the context token to be prefetched from the second KV cache based on an indication that indicates the key values are scheduled to be used by the compute circuitry of the GPU to execute the inference application. The method can also include causing the context token to be received from the second KV cache over the fabric using the memory coherency protocols and storing the context token as another active token in the first KV cache.

Example 12. The method of example 10 can also include evicting, responsive to an LRU policy for the second KV cache, the context token from the second KV cache. The method can also include causing the evicted context token to be stored to non-volatile memory as historical context tokens. The non-volatile memory can be maintained on a second memory device. The non-volatile memory can be accessible through a communication link that does not use memory coherent protocols.

Example 13. The method of example 12, the second memory device can be a solid state drive and the communication link is operated according to an NVMe specification.

Example 14. The method of example 10, the compute circuitry of the accelerator can execute the inference application responsive to a request. For this example, the method can also include determining that the request has become inactive and causing the context token to be stored to non-volatile memory as historical context tokens. The non-volatile memory can be maintained on a second memory device. The non-volatile memory can be accessible through a communication link that does not use memory coherent protocols.

Example 15. The method of example 10, the pooled persistent memory maintained on the memory device can be battery-backed dynamic random access memory, ferroelectric random access memory or magnetoresistive random access memory.

Example 16. The method of example 10, the memory coherent protocols can be CXL memory coherent protocols.

Example 17. The method of example 16, the pooled persistent memory can be host-managed device memory (HDM) configured to use the CXL memory coherent protocols based on a device coherent (HDM-D) configuration or a device coherent using back-invalidate snoop (HDM-DB) configuration.

Example 18. An example at least one machine readable medium can include a plurality of instructions that in response to being executed by a system can causes the system to carry out a method according to any one of examples 10 to 17.

Example 19. An example apparatus can include means for performing the methods of any one of examples 10 to 17.

Example 20. An example at least one machine readable medium can include a plurality of instructions that in response to being executed by compute circuitry of an accelerator device, can cause the compute circuitry to initiate model training for an artificial intelligence model. The model training can include the compute circuitry to utilize a high bandwidth memory at the accelerator and to generate one or more training check point versions during the model training. The instructions can also cause the compute circuitry to cause the one or more training check point versions to be stored in a pooled persistent memory on a memory device coupled with the accelerator device through a fabric. The pooled persistent memory can be accessible to the accelerator device and one or more other accelerators through the fabric using memory coherent protocols. The instructions can also cause the compute circuitry to detect that a failure has occurred during the model training. The instructions can also cause the compute circuitry to cause the model training to be paused. The instructions can also cause the compute circuitry to obtain, through the fabric using the memory coherent protocols, at least one training check point version of the one or more check point versions stored in the pooled persistent memory. The instructions can also cause the compute circuitry to store the at least one training check point version to the high bandwidth memory at the accelerator and restart the model training using the at least one training check point version.

Example 21. The at least one machine readable medium of example 20, the at least one training check point version can include model weights to be used in the model training.

Example 22. The at least one machine readable medium of example 20, the pooled persistent memory on the memory device can be battery-backed dynamic random access memory, ferroelectric random access memory or magnetoresistive random access memory.

Example 23. The at least one machine readable medium of example 20, the memory coherent protocols comprise CXL memory coherent protocols.

Example 24. The at least one machine readable medium of example 23, the pooled persistent memory can be host-managed device memory (HDM) configured to use the CXL memory coherent protocols based on a device coherent (HDM-D) configuration or a device coherent using back-invalidate snoop (HDM-DB) configuration.

Example 25. The at least one machine readable medium of example 20, the compute circuitry can be a graphics processing unit, a field programmable gate array, or an application specific integrated circuit.

Example 26. An example system can include a fabric, one or more memory devices to maintain pooled persistent memory that is accessible through the fabric by a plurality of accelerator devices using memory coherent protocols, and an accelerator device from among the plurality of accelerator devices. The accelerator device can include: a high bandwidth memory device configured to maintain a first cache and compute circuitry arranged to execute an inference application. The compute circuitry can be configured to store an active token in the first cache, the active token to include key values associated with the compute circuitry executing an inference application. The compute circuitry can also be configured to evict, responsive to an LRU policy for the first cache, the active token from the first cache. The compute circuitry can also be configured to cause, using the memory coherent protocols, the evicted active token to be stored in a second cache as a context token. The second cache can be included in the pooled persistent memory maintained on the memory device.

Example 27. The system of example 26, the compute circuitry can also be configured to cause the context token to be prefetched from the second cache based on an indication that indicates the key values are scheduled to be used by the compute circuitry to execute the inference application. The compute circuitry can also be configured to cause the context token to be received from the second cache over the fabric using the memory coherency protocols. The compute circuitry can also be configured to store the context token as another active token in the first cache.

Example 28. The system of example 26, the compute circuitry can also be configured to evict, responsive to an LRU policy for the second cache, the context token from the second cache. The compute circuitry can also be configured to cause the evicted context token to be stored to non-volatile memory as historical context tokens. The non-volatile memory can be maintained on a second memory device. The non-volatile memory can be accessible through a communication link that does not use memory coherent protocols.

Example 29. The system of example 28, the second memory device can be a solid state drive and the communication link can be operated according to an NVMe specification.

Example 30. The system of example 26, the compute circuitry can execute the inference application responsive to a request. The compute circuitry can be configured to determine that the request has become inactive. The compute circuitry can also be configured to cause the context token to be stored to non-volatile memory as historical context tokens. The non-volatile memory can be maintained on a second memory device. The non-volatile memory can be accessible through a communication link that does not use memory coherent protocols.

Example 31. The system of example 26, the pooled persistent memory maintained on the memory device can be battery-backed dynamic random access memory, ferroelectric random access memory or magnetoresistive random access memory.

Example 32. The system of example 26, the memory coherent protocols can be CXL memory coherent protocols.

Example 33. The system of example 32, the pooled persistent memory can be host-managed device memory (HDM) configured to use the CXL memory coherent protocols based on a device coherent (HDM-D) configuration or a device coherent using back-invalidate snoop (HDM-DB) configuration.

Example 34. The system of example 26, the compute circuitry can be a graphics processing unit, a field programmable gate array, or an application specific integrated circuit.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An accelerator device comprising:
a high bandwidth memory device configured to maintain a first cache; and
compute circuitry arranged to execute an inference application, wherein the compute circuitry is to:
store an active token in the first cache, the active token to include key values associated with the compute circuitry executing an inference application;
evict, responsive to a least recently used (LRU) policy for the first cache, the active token from the first cache; and
cause the evicted active token to be stored in a second cache as a context token, the second cache included in a pooled persistent memory maintained on a memory device coupled with the accelerator device through a fabric, the pooled persistent memory accessible by the accelerator device and at least one other accelerator device though the fabric using memory coherent protocols.

2. The accelerator device of claim 1, further comprising the compute circuitry to:
cause the context token to be prefetched from the second cache based on an indication that indicates the key values are scheduled to be used by the compute circuitry to execute the inference application;
cause the context token to be received from the second cache over the fabric using the memory coherency protocols; and
store the context token as another active token in the first cache.

3. The accelerator device of claim 1, further comprising the compute circuitry to:
evict, responsive to an LRU policy for the second cache, the context token from the second cache; and
cause the evicted context token to be stored to non-volatile memory as historical context tokens, the non-volatile memory maintained on a second memory device, the non-volatile memory accessible through a communication link that does not use memory coherent protocols.

4. The accelerator device of claim 3, wherein the second memory device comprises a solid state drive and the communication link is operated according to a Non-Volatile Memory Express (NVMe) specification.

5. The accelerator device of claim 1, the compute circuitry is to execute the inference application responsive to a request, wherein the compute circuitry is to:
determine that the request has become inactive; and
cause the context token to be stored to non-volatile memory as historical context tokens, the non-volatile memory maintained on a second memory device, the non-volatile memory accessible through a communication link that does not use memory coherent protocols.

6. The accelerator device of claim 1, wherein the pooled persistent memory maintained on the memory device comprises battery-backed dynamic random access memory, ferroelectric random access memory or magnetoresistive random access memory.

7. The accelerator device of claim 1, wherein the memory coherent protocols comprise Compute Express Link (CXL) memory coherent protocols.

8. The accelerator device of claim 7, wherein the pooled persistent memory comprises host-managed device memory (HDM) configured to use the CXL memory coherent protocols based on a device coherent (HDM-D) configuration or a device coherent using back-invalidate snoop (HDM-DB) configuration.

9. The accelerator device of claim 1, wherein the compute circuitry comprises a graphics processing unit, a field programmable gate array, or an application specific integrated circuit.

10. A method comprising:
storing an active token in a first key value (KV) cache maintained in a high bandwidth memory (HBM) device of a graphics processing unit (GPU), the active token to include key values associated with a compute circuitry of the GPU executing an inference application;
evicting, responsive to a least recently used (LRU) policy for the first cache, the active token from the first KV cache; and
causing the evicted active token to be stored in a second KV cache as a context token, the second KV cache included in a pooled persistent memory maintained on a memory device coupled with the GPU through a fabric, the pooled persistent memory accessible by the GPU and at least one other GPU though the fabric using memory coherent protocols and a shared memory address space.

11. The method of claim 10, further comprising:
causing the context token to be prefetched from the second KV cache based on an indication that indicates the key values are scheduled to be used by the compute circuitry of the GPU to execute the inference application;
causing the context token to be received from the second KV cache over the fabric using the memory coherency protocols; and
storing the context token as another active token in the first KV cache.

12. The method of claim 10, further comprising:
evicting, responsive to an LRU policy for the second KV cache, the context token from the second KV cache; and
causing the evicted context token to be stored to non-volatile memory as historical context tokens, the non-volatile memory maintained on a second memory device, the non-volatile memory accessible through a communication link that does not use memory coherent protocols.

13. The method of claim 12, wherein the second memory device comprises a solid state drive and the communication link is operated according to a Non-Volatile Memory Express (NVMe) specification.

14. The method of claim 10, wherein the compute circuitry of the GPU is to execute the inference application responsive to a request, the method further comprising:
determining that the request has become inactive; and
causing the context token to be stored to non-volatile memory as historical context tokens, the non-volatile memory maintained on a second memory device, the non-volatile memory accessible through a communication link that does not use memory coherent protocols.

15. The method of claim 10, wherein the pooled persistent memory maintained on the memory device comprises battery-backed dynamic random access memory, ferroelectric random access memory or magnetoresistive random access memory.

16. The method of claim 10, wherein the memory coherent protocols comprise Compute Express Link (CXL) memory coherent protocols.

17. At least one machine readable medium comprising a plurality of instructions that in response to being executed by compute circuitry of an accelerator device, causes the compute circuitry to:
initiate model training for an artificial intelligence model, the model training to include the compute circuitry to utilize a high bandwidth memory at the accelerator and to generate one or more training check point versions during the model training;
cause the one or more training check point versions to be stored in a pooled persistent memory on a memory device coupled with the accelerator device through a fabric, the pooled persistent memory accessible to the accelerator device and one or more other accelerators through the fabric using memory coherent protocols;
detect that a failure has occurred during the model training;
cause the model training to be paused;
obtain, through the fabric using the memory coherent protocols, at least one training check point version of the one or more check point versions stored in the pooled persistent memory;
store the at least one training check point version to the high bandwidth memory at the accelerator; and
restart the model training using the at least one training check point version.

18. The at least one machine readable medium of claim 17, wherein the at least one training check point version includes model weights to be used in the model training.

19. The at least one machine readable medium of claim 17, wherein the pooled persistent memory on the memory device comprises battery-backed dynamic random access memory, ferroelectric random access memory or magnetoresistive random access memory.

20. The at least one machine readable medium of claim 17, wherein the memory coherent protocols comprise Compute Express Link (CXL) memory coherent protocols.

21. A system comprising:
a fabric;
one or more memory devices to maintain pooled persistent memory that is accessible through the fabric by a plurality of accelerator devices using memory coherent protocols; and
an accelerator device from among the plurality of accelerator devices, the accelerator device to include:
a high bandwidth memory device configured to maintain a first cache; and
compute circuitry arranged to execute an inference application, wherein the compute circuitry is to:
store an active token in the first cache, the active token to include key values associated with the compute circuitry executing an inference application;
evict, responsive to a least recently used (LRU) policy for the first cache, the active token from the first cache; and
cause, using the memory coherent protocols, the evicted active token to be stored in a second cache as a context token, the second cache included in the pooled persistent memory maintained on the memory device.

22. The system of claim 21, further comprising the compute circuitry to:
cause the context token to be prefetched from the second cache based on an indication that indicates the key values are scheduled to be used by the compute circuitry to execute the inference application;
cause the context token to be received from the second cache over the fabric using the memory coherency protocols; and
store the context token as another active token in the first cache.

23. The system of claim 21, further comprising the compute circuitry to:
evict, responsive to an LRU policy for the second cache, the context token from the second cache; and
cause the evicted context token to be stored to non-volatile memory as historical context tokens, the non-volatile memory maintained on a second memory device, the non-volatile memory accessible through a communication link that does not use memory coherent protocols.

24. The system of claim 23, wherein the second memory device comprises a solid state drive and the communication link is operated according to a Non-Volatile Memory Express (NVMe) specification.

25. The system of claim 21, the compute circuitry is to execute the inference application responsive to a request, wherein the compute circuitry is to:
determine that the request has become inactive; and
cause the context token to be stored to non-volatile memory as historical context tokens, the non-volatile memory maintained on a second memory device, the non-volatile memory accessible through a communication link that does not use memory coherent protocols.
